(19) United States
(12) Patent Application Publication
(10) Pub. No.: US 2016/0105627 A1
(43) Pub. Date: Apr. 14, 2016

(54) Assignment and characteristics of multiple letters, characters, numbers, strokes and symbols to an individual physical key on a physical keypad integrated into an external remote control device and used for data input on the screen of the electronic device

(71) Applicants: Gary Streuter, Laguna Niguel, CA (US); William Pat Price, Henderson, NV (US)

(72) Inventors: Gary Streuter, Laguna Niguel, CA (US); William Pat Price, Henderson, NV (US)

(21) Appl. No.: 14/866,498

(22) Filed: Sep. 25, 2015

Related U.S. Application Data
(60) Provisional application No. 62/062,841, filed on Oct. 11, 2014.

(51) Int. Cl. H04N 5/44

(52) U.S. Cl. CPC H04N 5/4403; H04N 2005/4441

(57) ABSTRACT

The present invention allows for multiple letters, characters, numbers, strokes and symbols to be assigned to a given physical key on a physical keypad residing in a hand held remote control device used for DATA entry on the viewing screen of an electronic device and the methodology of automatically displaying and inserting the assigned DATA assigned to that physical key on the viewing screen of the electronic device. As the user continues to touch/press said physical key on the external remote control keypad, a software module will display and bring into focus the DATA assigned to the appropriate time duration of the continued touch/press of said physical key in a visual manner on the viewing screen of the electronic device and will continue rotating thru the assigned DATA as long as the physical key touch/press continues. When the user releases the touch/press of said physical key, said software module will present the DATA assigned to that time duration to the display software for insertion into the active DATA entry area on the display screen.

Assignment and characteristics of multiple letters, characters, numbers, strokes and symbols to an individual physical key on a physical keypad integrated into an external remote control device and used for data input on the screen of the electronic device.

This application claims priority from provisional application No. 62/062,841, filed Oct. 11, 2014, the entire contents of which are herewith incorporated by reference.

### FIELD OF INVENTION

The field of invention relates to physical key pads residing in hand-held remote control devices which are used on electronic devices such as, but not limited to, TV sets, multimedia players, game consoles, or any other electronic devices where said external remote control is used to provide character input on the viewing screen of the electronic device.

### BACKGROUND

The advent of devices such as Smart TV's, streaming media-players, optical media players, and game consoles has driven the requirement for users of these electronic devices to enter a great deal of data required for the proper setup and operation of the electronic device. These requirements can include inputting personal information required for setup and registration, search terms, license acceptances, personal favorites indicators and content selections among other functions. This data entry task is today typically handled by the use of a virtual keyboard embedded in the firmware of the electronic device, where such virtual keyboard can be operated by either a touch screen mode if supported, or by using an external device such as an external IR/WiFi/Bluetooth remote control device with an embedded physical keypad, or by interfacing an external wired or wireless physical keyboard for the inputting of DATA such as letters, characters, numbers, strokes and symbols as well as text and navigation entries. Using a keypad on an external remote control can be very frustrating for the user, as it requires the sustained use of what are known as the remote transport keys (up/down & right/left) in order to move the selection focus to the proper character on the virtual keyboard within the electronic device. When smart devices began to appear, full keyboards began to be virtualized. These are also often referred to as soft keyboards. These keyboards are displayed on a portion of the display screen of the electronic device, generally at the bottom of the display screen. Typically a virtual/soft keyboard will display a QWERTY based keyboard design of a-z where an additional key has a “Shift” function which changes the appearance of the keyboard to all capital letters. If the user wants to enter a complete word in capitals they have to press the shift key prior to entering each letter in the word or engage a “Caps Lock” key, if supported by the device. Often, if the user wants to enter numbers and symbols they often must press another special key that gives them access to numbers and symbols on another layer of their virtual/soft keyboard. When they have finished entering the numbers and symbols from that secondary layer, they must often then press another special key to revert back to the lower case alpha library shown of the first layer of the virtual/soft keyboard. Because of the need to use the transport keys on the external remote control to bring into focus the desired character, it often requires the user to execute many more transport key movements than would have been required if using the technology referenced in this disclosure.

### PROBLEM STATEMENT

What is needed is a method of simplifying and improving the DATA entry process on non-touch screen electronic devices such as TV, streaming media-players and game consoles that rely on external remote control units to supply user input to the electronic device.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The shortcomings of relying on the transport keys on an external remote control device to bring the desired data into focus on the viewing screen of the electronic device are evident in the level of user frustration that exists in the market. Embedding a new character selection methodology into an external remote control can drastically reduce the amount of effort required to enter data as well as reducing the expense of embedding the technology into the display device. This methodology will also enable users to save keystrokes (and time) by using the DATA assigned to said key more quickly, as it can be accessed by the continued touch/press of said physical key on the external remote control device, which causes the DATA assigned to said physical key to come into focus in a rotary fashion.

### EMBODIMENTS

Reference will now be made in detail to various embodiments, examples of which are illustrated in the accompanying drawings. Wherever possible, the same reference numbers will be used throughout the drawings to refer to the same or like parts.

### Definitions

Continued press of said physical key: The measurement of elapsed time of the continued touch/press of a physical key located on the physical keypad or physical keyboard.

DATA: This represents the common and uncommon representations of letters, characters, numbers, strokes, symbols, and URLs used to communicate and can support multiple language sets as well as scientific notation.

DATA assigned to said physical key: This represents the letters, characters, numbers, strokes, symbols, and URLs that have been assigned from a plurality of arrays, for use by a individual physical key on the external remote control device.

Data Character: Any one of the letters, characters, numbers, strokes, symbols, or URLs defined in the above definitions.

Designated data entry area on the viewing screen of an electronic device to be controlled: A data entry location displayed on the display screen of an electronic device being controlled.

Duration of Time: The elapsed time during which DATA assigned in sequence to that physical key is in focus.

Electronic Device: A device containing a microprocessor and memory with computational capabilities.

External remote control device—An external device, usually hand-held, that can be hard wired to an electronic device to be controlled or may be connected to the electronic device to be controlled via a wireless communications link that is used to send control signals to the electronic device to be controlled

In Focus: The letter, character, number, stroke, symbol or URL that is currently at the top of the priority stack to be inserted into the designated data entry area of the viewing screen of the electronic device.

Order of Sequence: The order of assignment of letters, characters, numbers, strokes, symbols and URLs to said physical key in a hierarchical manner.

Physical Keyboard—Used interchangeably with Physical Keypad

Physical Keypad—A collection of physical data input buttons or keys on an external remote control device.

Rotary Effect: The circular repetition of DATA assigned to said physical key, once the total time duration assigned to said physical key has been completed and the touch/press of said physical key continues

Termination of the touch/press of a physical key: The release by the user of the continued touch/press of the physical key.

Touch Sensitive Viewing Screen: A display device for displaying DATA from an electronic device to a user that is constructed to respond to touch directly to the surface of the display screen.

Non-Touch Sensitive Viewing Screen: A display screen for displaying DATA from an electronic device to a user that is NOT constructed to respond to touch directly to the surface of the display device.

Viewing Screen of an Electronic Device: A display screen for presenting DATA from an electronic device to a user

Virtual Keyboard: Can also be defined as a soft keyboard that is displayed on the viewing screen of an electronic device and is used for DATA entry.

### BRIEF DESCRIPTION OF THE DRAWINGS

Now referencing the drawings where:

FIG. 1 is a depiction of the hand held remote control device with the necessary components shown.

FIG. 2 is a depiction of a generic hand held remote control device with a typical 10 key keypad and a depiction of a keypad compliant with the invention.

FIG. 3 is a depiction of an array of displayable data characters and smaller arrays which contain data characters assigned from the larger array of data characters.

FIG. 4 is a depiction of an array of displayable data characters and smaller arrays assigned to each key of the keypad where the index replaces the actual displayable data character.

FIG. 5 is a depiction of one array of assigned data characters assigned to a single key residing in the keypad and how the character in focus changes once a user presses and does not release the corresponding key.

FIG. 6 is a depiction of the display screen of an electronic device where the data input area is shown with 2 data characters being displayed.

### DETAILED DESCRIPTION OF THE INVENTION

Objects and advantages of the present invention will become apparent to those skilled in the art upon reading this description in conjunction with the accompanying drawings, in which like reference numerals have been used to designate like or analogous elements.

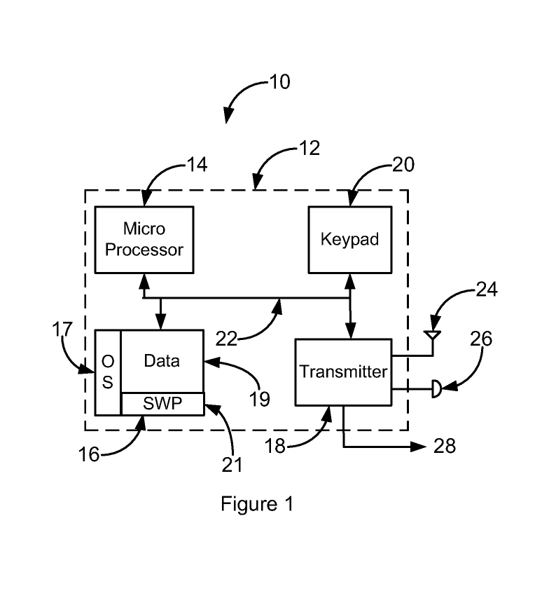

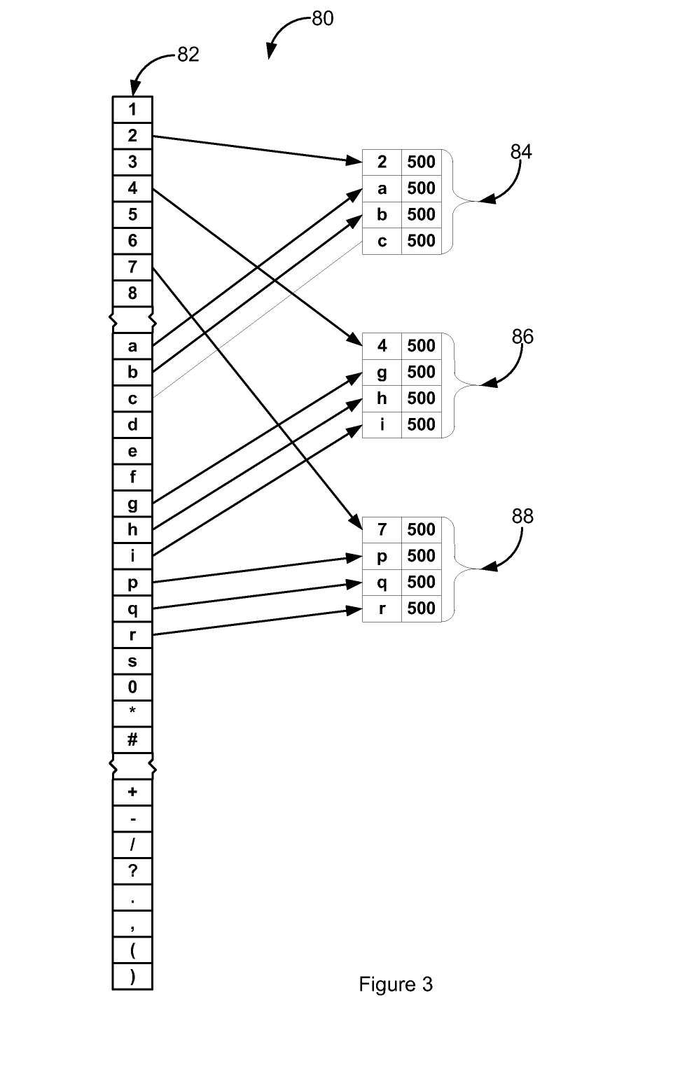

Now referencing FIG. 1 where depicts an embodiment of the invention. In this depiction, remote control device 12 contains microprocessor 14, memory 16 containing operating system (OS) 17, software program (SWP) 21, and data 19. In this depiction, microprocessor 14 receives signals from keypad 20. These signals are in the form of digital data that identifies a key being pressed on keypad 20. The digital data allows microprocessor 14 to identify an array of letters, characters, numbers, strokes, symbols otherwise referred to as the “data characters” assigned to the key being pressed (see FIG. 3). On initial detection of the key being pressed microprocessor 14 will send the first data character of the array of data characters via transmitter 18 to a device containing a display screen (not shown). Transmitter 18 may send the data character to the display screen via RF signals emitted by antenna 24 or via IR signals emitted by IR emitter 26. Modern televisions, for example, can generally receive control signals and data via RF through protocols such as wifi (802.11) or Bluetooth, or via some proprietary RF protocol. They can also generally receive control signals via IR protocols used by typical hand held remote controllers.

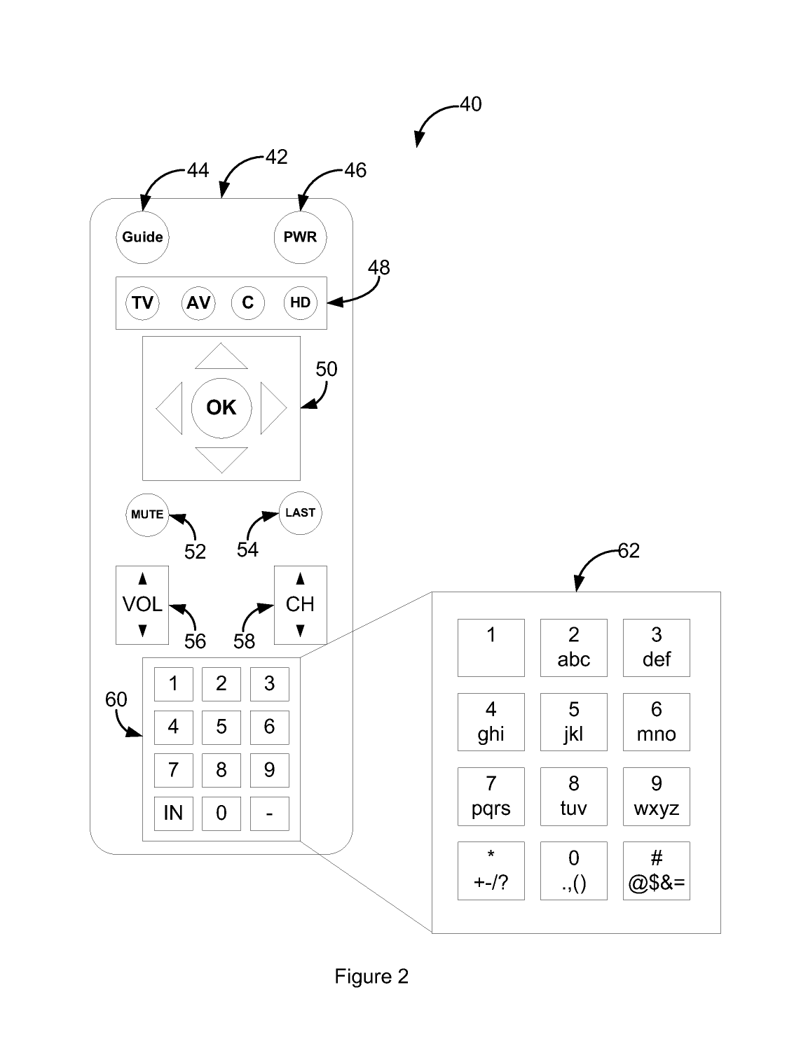

Now referencing FIG. 2 where 40 depicts a typical hand held remote control device 42 and a keypad (62) compliant with the present invention. In this depiction, a number of buttons and keys are present on remote control device 42. Note that a “guide” button 44 and a “pwr” button 46 are present at the top of the remote control device. This device also contains a series of input mode buttons 48 which will cause remote control device 42 to send a switch input mode for a TV. In this depiction, switch input mode includes TV (antenna), AV (external component input), C (cable), or HD (HDMI). In this depiction, remote control device also has buttons for navigation and OK selection 50, mute 52, last channel 54, volume control up and down 56, channel up and down 58, and a keypad 60 which is limited to numerical digits 0-9, a minus sign and IN (input mode). Also shown in this depiction is a keypad 62 that may be substituted for the standard keypad 60. Note that keypad 62 contains 12 keys like standard keypad 60. Also note that keypad 62 has additional characters represented on keys 2-0 and * and # keys. Keypad 62 is a compliant keypad of the invention. In this depiction, if a user presses key 2 of keypad 62, the number “2” will be sent to the television which will display the character in the data input area of the display. If the user continues to press key 2, after some assigned duration, the remote control device 42 will send a “backspace” character to the television followed by the letter “a” to the television Likewise, if the user continues to press key 2, remote control device 42 will send, after the appropriate time duration, a “backspace” character followed by the letter “b”, and likewise the letter “c” after which, if the user continues to press the selected key, remote control device will send a backspace to the television followed by the number “2”. This rotor effect will continue until the user releases the key and the character that was present when the key is released will be the character placed into the data input area of the display.

Now referencing FIG. 3 Where 80 depicts displayable data character array 82 and smaller arrays assigned to specific keys of keypad 62. For the sake of clarity, only the arrays for three keys (“2”, “4”, and “7” are shown. Note that each key array contains two columns where one column contains a sequence of data characters and the other column contains a series of numbers which represent in milliseconds the amount of time the data character in the adjacent data character column will remain on the display screen before the next data character in the data character array will be displayed. Note that keypad array 84 for key “2” contains four data characters these being “2”, “a”, “b”, and “c”. Keypad array 86 for key “4” contains four data characters these being “4”, “g”, “h”, and “i”. Keypad array 84 for key “7” contains four data characters these being “7”, “p”, “q”, and “r”. When the remote control device is booted, software program 21 will assign data characters from data character array 82 to the array assigned to each key resident in keypad 62 and will assign the number of milliseconds each data character will remain on the display if the user does not release the key he is currently pressing.

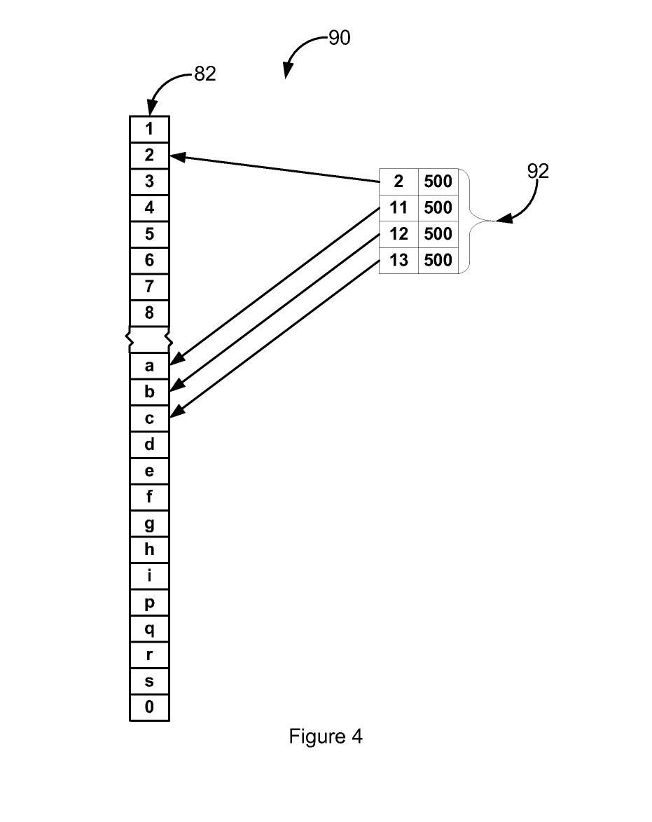

Now referencing FIG. 4 where 90 depicts displayable data character array 82 and one of a plurality of smaller arrays assigned to specific keys of keypad 62. For the sake of clarity, only the array for one key is shown, that being the “2” key. Note that this key array contains two columns where one column contains an index to each of a sequence of data characters “2”, “a”, “b”, and “c”. The second column contains a series of numbers which represent in milliseconds the amount of time the data character in the adjacent data character column will remain on the display screen before the next data character in the data character array will be displayed. Data character array 82 contains the same data in both FIGS. 3 and 4 while key array 84 contains the actual sequential data characters key array 92 contains an index back to individual data characters in data character array 82.

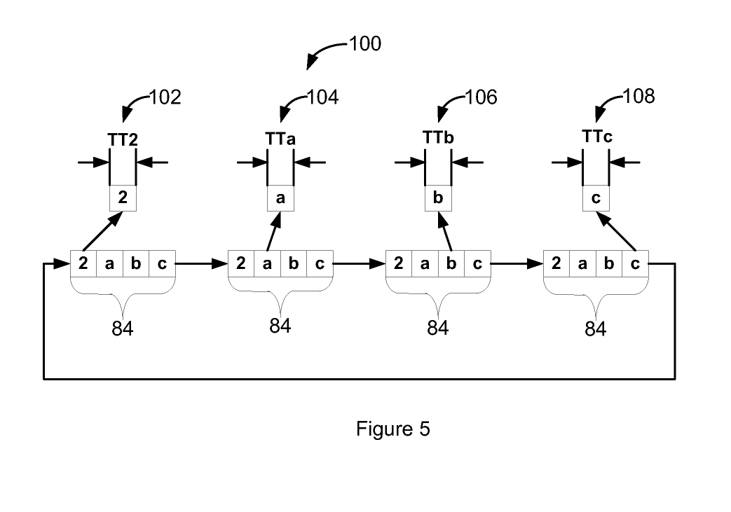

Now referencing FIG. 5 where 100 depicts data character 84 which contains displayable characters “2”, “a”, “b”, and “c”. When a user presses the “2” key residing on keypad 62, remote control device 42 under control of software program 21 will transmit data character “2” to a display device such as a television which will display the transmitted data character (“2”) in the data input area on the display screen. If the user continues to press the “2” key, time TT2 (102) will expire and remote control device will then transmit a “backspace” data character to the television which will cause cursor 118 to backup and display a space after which remote control device will then transmit the next data character in sequence, which in this depiction, will be the “a” data character which the television will then display at the current cursor position. If the user does not release the pressed key, software program 21 will continue, every time the timer value (TT2, TTa, TTb, and TTc) associated with its displayable data character expires, send a back space followed by the next sequential data character to be displayed. Once data character “c” is displayed and its associated timer value expires, software program 21 will send a backspace followed by the first sequential data character in data key array 84 which in this case if the data character “2”. This loop action will continue until the user releases the key “2” and whatever displayable data character is currently being displayed will remain in data input area 116 at the current cursor 118 position prior to cursor 118 being advanced by the television to the next character position.

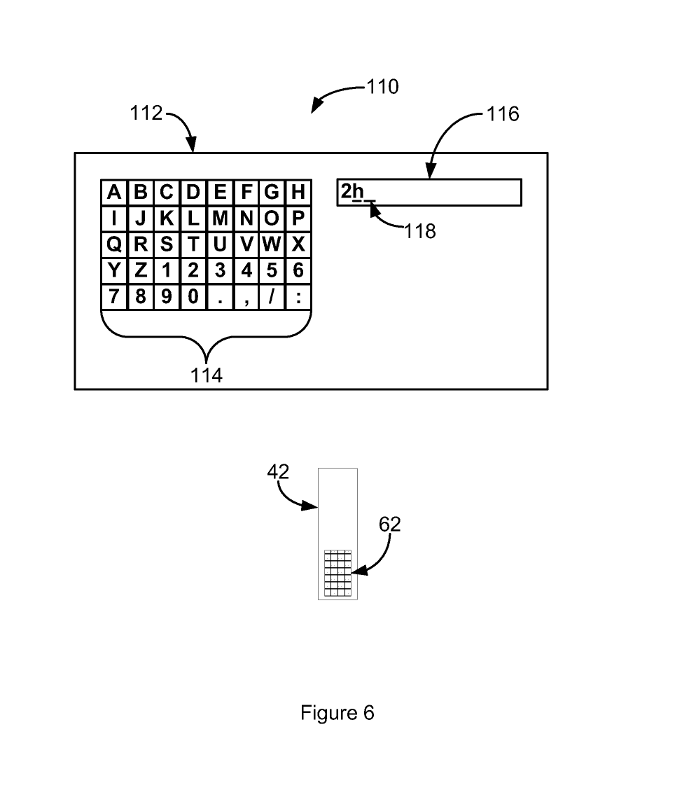

Now referencing FIG. 6 where 110 depicts the invention embedded within remote control device 42. Shown on remote control device 42 is a keyboard 62 which is compatible with the invention. In this depiction, the user has selected an application on his television 112. The application has displayed a virtual keyboard 114 that can be navigated using the Up, Down, Left, and Right arrow keys or buttons as depicted in FIG. 2, object 50. In the current depiction of FIG. 6, the user has already entered a single character, that being “2”. The user next presses the “4” key (FIG. 2 keyboard 60, depiction of the “4” key) and has waited for 3 character times until the “h” data character is displayed. As soon as the “h” character is displayed, cursor 118 will be advanced to the next blank input character space. In the current depiction the cursor appears under the character current being displayed and to the right of that character. To the eye, the cursor will be momentarily displayed in both positions because when the current data character timer expires, remote 42 will transmit a “backspace” data character to television 112. This will cause cursor 118 to be backed up and displayed after which remote 42 will transmit the next data character, which in this depiction is the data character “h” which will be displayed and the cursor will advance to the next character space. For a short amount of time, cursor 118 may appear to the user as being in both positions. When the user has entered all of the characters he intended to enter he will press the “OK” button depicted in FIG. 2 object 50 or some other suitable button that terminates the data input mode of the television. Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other techniques of synchronization can be used. For example while FIG. 7 shows file closing events and file deleting events causing the file to be changed on the duplicate partition, this can be done at time intervals instead.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification. Operations as described herein can be carried out on or over a website. The website can be operated on a server, computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A system incorporating an external remote control device with an embedded physical keypad where selected physical keys contained within a keypad on said external remote control device have the ability to cause to be transmitted, in a sequential fashion, a plurality of sequential data characters assigned to each of said physical keys, to an electronic device containing a display screen where the sequential data characters are to be inserted into a designated data input area on the display screen comprising:
a. a microprocessor embedded within said external remote control device which executes software programs,
b. a physical keypad with individual keys operable coupled to said microprocessor;
c. a first software program executing on said microprocessor residing in said external remote control device and assigns data characters and attributes to at least a first individual key residing on said keypad of said external remote control device;
d. said first software program assigns to said first individual key a plurality of data characters in a specific order of sequence and an attribute consisting of a time duration for each of said data characters;
e. said first software program will use said time duration to determine the amount of time after a data character has been transmitted to said electronic device before the next sequential data character is transmitted to said electronic device while a user continues to press said individual key;
f. said first software program will, after said first data character has been send to said display device, precede subsequent data characters with a backspace data character allowing a previous displayed data character to be overwritten by the current data character to be sent to said display device;
g. said first software program will, when all of said sequence of assigned data characters have been sent to said display device, begin again with sending said first data character in said sequence of said data characters assigned to said key being continuously pressed by said user;
h. said first software program will, when said user terminates his pressing of said physical key, not transmit any additional data characters or backspace data characters to said electronic device;
i. if said user subsequently presses any of said physical keys on said keypad said first software program will repeat steps a through e through h.

2. The system of claim 1 whereby said data characters assigned to said physical keys by said first software program may be visually displayed on each physical key of said physical keypad in a manner denoting to the user the specific order of sequence in which they were assigned to said key representation of the data character may be based on the position on the key or any other visual representation or overlay that indicates to the user the specific order of sequence associated with that data character.

3. A method controlled by a first software program executing on a microprocessor embedded in a remote control device, for transmitting a selected data character from a plurality of data characters assigned to individual physical keys on a keypad embedded on the remote control device, for reception and display by an electronic device with a display screen comprising:
a. sending to electronic device a first data character in a sequence of data characters assigned to a physical key on said keypad where said physical key is pressed by a user;
b. said sequence of assigned data character, each assigned a timer value, which is used to determine the amount of time after a data character has been transmitted to said electronic device before said first software program transmits the next sequential assigned data character to said electronic device;
c. said sequential data characters sent to said electronic device after said first data character has been send to said electronic device will be preceded by a backspace data character allowing a previous displayed data character to be overwritten by the current data character to be sent to said display device;
d. when all of said sequence of assigned data characters have been sent to said electronic device, said first software program will begin again by sending said first data character in said sequence of said data characters assigned to said key being continuously pressed by said user;
e. when said user terminates his pressing of said physical key there shall be no further transmission of additional data characters to said electronic device;
f. if said user subsequently presses any of said physical keys on said keypad said first software program will repeat steps a through e.

4. The method of claim 3 whereby each data character assigned to said key embedded said keypad of said remote control device is assigned a sequenced duration of time within the continued touch or press of said key and said duration of time of the continued press determines the selection of focus of the data character assigned to said key.

5. The method of claim 3 whereby the specific order of sequence for data characters assigned to said key may be variable based on the measurement of the accumulated usage of each assigned data character.

6. The method of claim 3 whereby the data characters assigned to said physical key are visually displayed on each of said key of said remote control device.

7. The method of claim 6 whereby the data characters assigned to each of said physical keys may be visually displayed on each of said physical keys of said remote control device in a manner which denotes to the user the specific order of sequence in which they are assigned to each of said physical keys and the order of sequence may be represented to the user by:
a: the position on the key to denote the specific order of sequence
b: any other visual representation or overlay that indicates to the user the specific order of sequence associated with that data character assigned to that physical key.

8. The method of claim 3 whereby each of the plurality of data characters assigned to an individual physical key on a keypad residing in said remote control device is a set of two data characters where the first data character of the set is a backspace data character to be sent to said electronic device prior to the second data character of the set being sent to said electronic device except for the first time a data character is sent to said electronic device when any of said physical keys is pressed by said user.
